(19) United States
(12) Patent Application Publication
(10) Pub. No.: US 2009/0291597 A1
(43) Pub. Date: Nov. 26, 2009

(54) METHOD AND APPARATUS TO COUPLE AN EXTERNAL DEVICE TO, AND POWER THE EXTERNAL DEVICE FROM, AN INFORMATION HANDLING SYSTEM

(75) Inventors: Ayedin Nikazm, Austin, TX (US); James Utz, Round Rock, TX (US); Andrew Sultenfuss, Leander, TX (US)

Correspondence Address: LARSON NEWMAN & ABEL, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 12/124,848

(22) Filed: May 21, 2008

(51) Int. Cl. H01R 24/04

(52) U.S. Cl. 439/668

(57) ABSTRACT

A plug to couple an external device to, and power the external device from, an information handling system includes first contacts conforming to a first industry standard. The first contacts include a first power contact adapted to conduct a first power signal from the information handling system to the external device. The plug also includes second contacts conforming to a second industry standard different from the first industry standard. The second contacts are designed to conduct no more than one second power signal from the information handling system to the external device. In a particular embodiment, the first contacts conform to a USB standard, and the second contacts conform to a non-USB standard.

### FIELD OF THE DISCLOSURE

This disclosure relates generally to methods and apparatuses to couple an external device to, and power the external device from, an information handling system.

### DESCRIPTION OF THE RELATED ART

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems.

### BRIEF DESCRIPTION OF THE DRAWINGS

Skilled artisans appreciate that elements in the figures are illustrated for simplicity and clarity and have not necessarily been drawn to scale. For example, the dimensions of some of the elements in the figures may be exaggerated or minimized relative to other elements to help to improve understanding of embodiments of the disclosed apparatus. Embodiments incorporating teachings of the present disclosure are illustrated and described with respect to the drawings presented herein.

FIG. 1 is a diagram illustrating a particular embodiment of a system to couple an external device to, and power the external device from, an information handling system;

FIG. 2 is a block diagram illustrating a second particular embodiment of a system to couple an external device to, and power the external device from, an information handling system;

FIGS. 3A-3C are diagrams illustrating a particular embodiment of an apparatus to couple an external device to, and power the external device from, an information handling system;

FIG. 4 is a general diagram illustrating a particular embodiment of a cable to couple an external device to, and power the external device from, an information handling system; and

FIG. 5 is a flow diagram illustrating a particular embodiment of a method of coupling an external device to, and powering the external device from, an information handling system.

The use of the same reference symbols in different figures indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application. The teachings can also be utilized in other applications and with several different types of architectures such as distributed computing architectures, client/server architectures, or middleware server architectures and associated components.

For purposes of this disclosure, an information handling system can include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a PDA, a consumer electronic device, a network server or storage device, a switch router, wireless router, or other network communication device, or any other suitable device and can vary in size, shape, performance, functionality, and price. The information handling system can include memory (volatile (e.g. random access memory, etc.), nonvolatile (read only memory, flash memory etc.) or any combination thereof), one or more processing resources, such as a central processing unit (CPU), hardware or software control logic, or any combination thereof. Additional components of the information handling system can include one or more storage devices, one or more communications ports for communicating with external devices as well as various input and output (I/O) devices, such as a keyboard, a mouse, a video display, or any combination thereof. The information handling system can also include one or more buses operable to transmit communications between the various hardware components.

Although referred to as a “device,” the device may be configured as hardware, firmware, software, or any combination thereof. For example, the device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). Similarly, the device could be firmware (such as any software running on an embedded device, a Pentium class or PowerPC™ brand processor, or other such device) or software (such as any software capable of operating in the relevant environment). The device could also be a combination of any of the foregoing examples of hardware, firmware, or software.

Devices or programs that are in communication with one another need not be in continuous communication with each other unless expressly specified otherwise. In addition, devices or programs that are in communication with one another may communicate directly or indirectly through one or more intermediaries.

Embodiments discussed below describe, in part, distributed computing solutions that manage all or part of a communicative interaction between network elements. In this context, a communicative interaction may be intending to send information, sending information, requesting information, receiving information, receiving a request for information, or any combination thereof. As such, a communicative interaction could be unidirectional, bi-directional, multi-directional, or any combination thereof. In some circumstances, a communicative interaction could be relatively complex and involve two or more network elements. For example, a communicative interaction may be “a conversation” or series of related communications between a client and a server—each network element sending and receiving information to and from the other. Whatever form the communicative interaction takes, the network elements involved need not take any specific form. A network element may be a node, a piece of hardware, software, firmware, middleware, some other component of a computing system, or any combination thereof.

In the description below, a flow-charted technique may be described in a series of sequential actions. The sequence of the actions and the party performing the steps may be freely changed without departing from the scope of the teachings. Actions may be added, deleted, or altered in several ways. Similarly, the actions may be re-ordered or looped. Further, although processes, methods, algorithms or the like may be described in a sequential order, such processes, methods, algorithms, or any combination thereof may be operable to be performed in alternative orders. Further, some actions within a process, method, or algorithm may be performed simultaneously during at least a point in time (e.g., actions performed in parallel), can also be performed in whole, in part, or any combination thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single device is described herein, more than one device may be used in place of a single device. Similarly, where more than one device is described herein, a single device may be substituted for that one device.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the computing, electronics, and software arts.

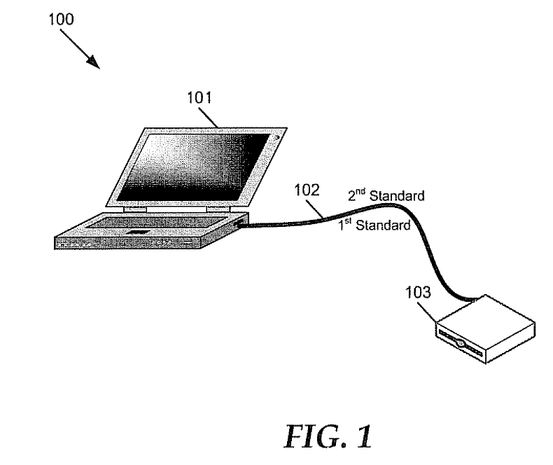

FIG. 1 illustrates a particular embodiment of a system 100 to couple an external device to, and power the external device from, an information handling system. The system 100 includes an information handling system 101 coupled to an external device 103 via a cable 102. The information handling system 101 can include a local or distributed computing system, such as a server computer, a laptop computer, a desktop computer, a terminal computing device, another type of device, or any combination thereof. The external device 103 can include, for instance, an external storage device, an external optical drive, another external drive, another type of external device, or any combination thereof. The external device 103 is adapted to receive power from the computing device 102 when coupled to the information handling system 101 or to an electrical outlet. In addition, the external device 103 is adapted to send data to, and receive data from, the information handling system 101 when coupled to a data interface of the information handling system 101, such as a USB interface, an external serial advanced technology attachment (eSATA) interface, a data interface conforming to another industry standard, or any combination thereof.

The cable 102 is adapted to conduct power signals from the information handling system 101 to the external device 103 and to simultaneously conduct data signals between the information handling system 101 and the external device 103. The cable 102 includes a plug that is adapted to couple the cable 102 to a connector at the information handling system 101. The connector includes a portion conforming to a first industry standard and a portion conforming to a second, different industry standard. The plug includes contacts that conform to the first industry standard, including a power contact adapted to conduct a power signal from the connector to the external device 103 via the cable 102. The contacts that conform to the first industry standard can also include one or more data contacts adapted to conduct at least one data signal from the information handling system 101 to the external device 103. Further, the plug includes additional contacts conforming to the second industry standard. The additional contacts are adapted to conduct no more than one additional power signal from the information handling system 101 to the external device 103. In one embodiment, the additional contacts can include one or more ground contacts that each conduct power signals having substantially equal voltages. The additional contacts can also include one or more data contacts adapted to conduct at least one data signal between the information handling system 101 to the external device 103.

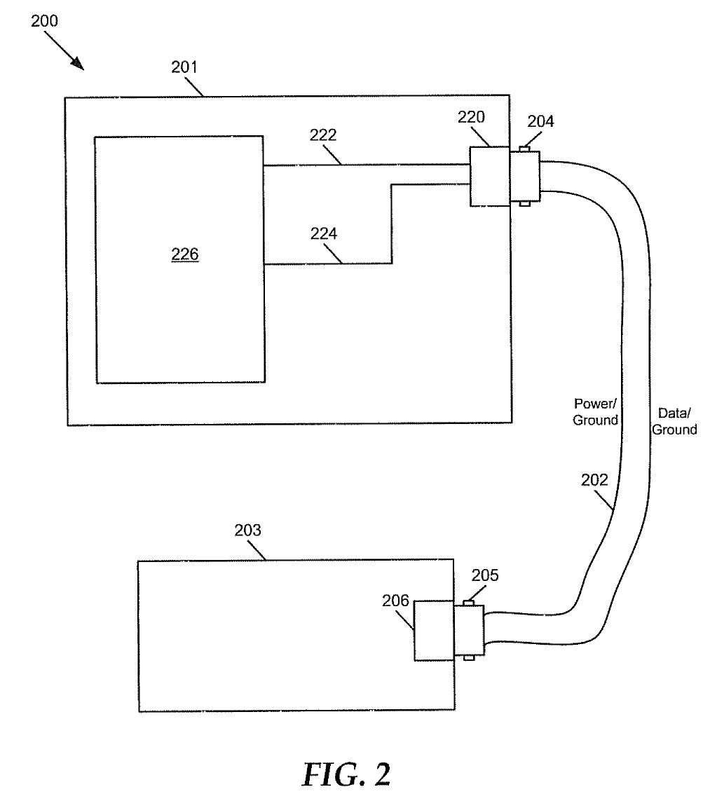

FIG. 2 illustrates a second particular embodiment of a system 200 to couple an external device to, and power the external device from, an information handling system. The system 200 includes an information handling system 201 coupled to an external device 203 via a cable 202. The information handling system 201 includes a combination connector 220 having a portion adapted to receive a plug conforming to a first industry standard and a portion adapted to receive a plug conforming to a second, different industry standard. The combination connector 220 is connected to a printed circuit board 226, such as a motherboard of the information handling system 201, via a bus 222 conforming to the first industry standard, and via another bus 224 conforming to the second industry standard.

A plug 204 is coupled to one end of the cable 202. The plug 204 is adapted to be coupled simultaneously to both the portion of the combination connector 220 conforming to the first industry standard and to the portion of the combination connector 220 conforming to the second industry standard. Further, the plug 204 is adapted to simultaneously communicate via the connector 220 with the bus 222 and with the bus 224 of the information handling system 201.

In a particular embodiment, the plug 204 includes a plurality of contacts conforming to the first industry standard, including a power contact adapted to conduct a power signal, from the portion of the connector 220 conforming to the first industry standard, to the external device 203 via the cable 202. The contacts can also include one or more data contacts adapted to conduct one or more data signals, from the portion of the connector 220 conforming to the first industry standard, to the external device 203. In addition, the plug 204 includes a plurality of additional contacts conforming to the second industry standard, including one or more power contacts adapted to conduct no more than one additional power signal, from the portion of the connector 220 conforming to the second industry standard, to the external device 203 via the cable 202. For instance, the additional contacts can include one or more ground contacts. The additional contacts can also include one or more data contacts adapted to conduct one or more data signals, from the portion of the connector 220 conforming to the second industry standard, to the external device 203.

The cable 202 can also include an additional plug 205 that is coupled to another end of the cable 202. The additional plug 205 is adapted to be coupled to a connector 206 at the external device 203. The additional plug 205 can include contacts that conform to the first industry standard, the second industry standard, or a combination thereof. The contacts can be disposed in a single row or in multiple rows. For example, the additional plug 205 can be substantially identical to the plug 204. In other embodiments, multiple plugs can be coupled to the other end of the cable 202, where each plug conforms to a different industry standard. In other embodiments, the other end of the cable 202 can be integrated with the external device 203 without a plug-connector interface.

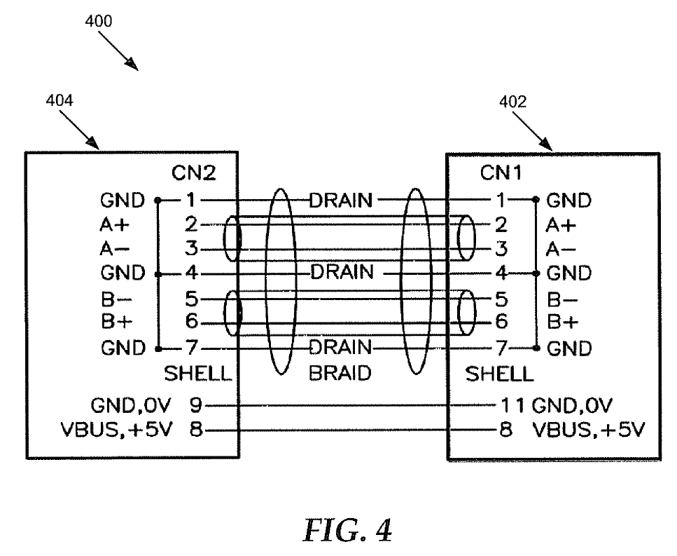

Further, the cable 202 includes a plurality of wires or leads that connect the contacts of the plug 204 with the external device 203 via a plurality of contacts of the additional plug 205 or, alternatively, via direct connection with elements of the external device 203, such as buses, printed circuit boards or other elements. Examples of such wires or leads are illustrated in FIG. 4. The plurality of wires or leads are adapted to simultaneously conduct (i) a power signal received at the contacts (conforming to the first industry standard) of the plug 204, and (ii) no more than one power signal received at the additional contacts (conforming to the second industry standard) of the first plug 204. The plurality of wires or leads can also be adapted to conduct one or more data signals received at the contacts of the first plug 204, one or more data signals received at the additional contacts of the first plug 204, or any combination thereof.

In an illustrative embodiment, the contacts of the plug 204 can include USB contacts, and the additional contacts of the plug 204 can include non-USB contacts. For instance, the connector 220 at the information handling system 201 can have a USB portion and an eSATA portion. The connector 220 can include a pin substrate having a plurality of USB pins on one side and a plurality of eSATA pins on another side. The plug 204 can include a shell adapted to surround the pin substrate of the connector 220. The shell can have a plurality of USB contacts on one inner surface and a plurality of eSATA contacts on another inner surface. The plurality of USB contacts can include a power contact adapted to conduct a first power signal from the USB portion of the connector to the external device 203 via one of the wires or leads. The plurality of eSATA contacts can include a plurality of data contacts and a plurality of ground contacts, where the eSATA contacts are adapted to conduct data signals, no more than one additional power signal, or a combination thereof, from the eSATA portion of the connector 220 to the external device 203 while the USB contacts simultaneously conduct the power signal, one or more data signals, or a combination thereof, to the external device 203.

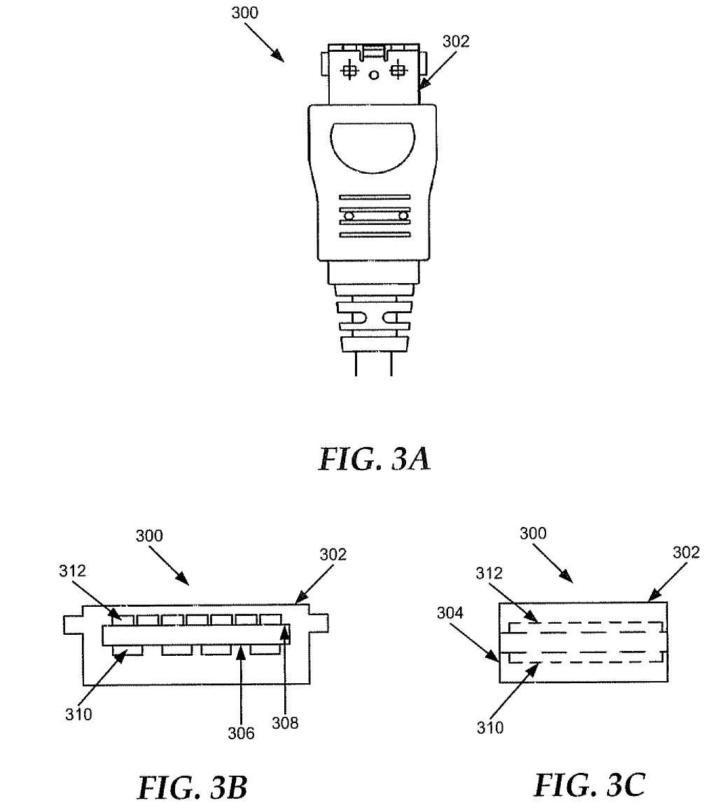

FIGS. 3A-3C illustrate a third particular embodiment of an apparatus 300 to couple an external device to, and power the external device from, an information handling system. The apparatus 300 includes a shell 302, such as a metal casing, plastic casing or other shell. In one embodiment, the shell 302 is characterized by a size that conforms to an eSATA standard. In other embodiments, the shell 302 can have another size. The shell 302 has an inner surface 306 and an additional inner surface 308 substantially parallel to the inner surface 306. A plurality of contacts conforming to a first industry standard are disposed on the inner surface 306 and a plurality of additional contacts conforming to a second industry standard different from the first industry standard are disposed on the additional inner surface 308. For instance, a plurality of USB contacts 310 can be disposed on the inner surface 306, and a plurality of non-USB contacts 312 can be disposed on the additional inner surface 308. The plurality of USB contacts 310 includes a USB power contact, a ground contact and a plurality of USB data contacts. The plurality of non-USB contacts 312 can include a plurality of data contacts. In addition, the plurality of non-USB contacts 312 are adapted to conduct no more than one additional power signal. For instance, the plurality of non-USB contacts can include one or more ground contacts.

As illustrated in FIG. 3C, the inner surface 306 and the additional inner surface 308 are substantially parallel to one another, such that the plurality of USB contacts 310 is substantially parallel to the plurality of non-USB contacts 312. A space is disposed between the plurality of USB contacts 310 and the plurality of non-USB contacts 312, such that the shell 302 is adapted to surround a pin substrate of a connector, where a plurality of USB pins (or other types of contacts) are disposed on one side of the pin substrate and a plurality of non-USB pins (or other types of contacts) are disposed on another side of the pin substrate, where the sides of the pin substrate are substantially parallel. The plurality of USB contacts 310 and the plurality of non-USB contacts 312 can comprise teeth, pins, other contacts or any combination thereof.

In one embodiment, the plug 300 includes a tip 304 sized to be received within the connector. The plurality of USB contacts 310 and the plurality of non-USB contacts 312 are substantially equidistant from the tip 304, such that the USB contacts 310 contact the plurality of USB pins, and the plurality of non-USB contacts 312 contact the plurality of non-USB pins, simultaneously when the plug 300 is inserted into the connector. In alternative embodiments, the plug 300 can comprise a male component including a pin substrate having the USB contacts 310 on one side and the non-USB contacts 312 on another substantially parallel side, and the connector can comprise a female component having USB contacts on one inner surface and non-USB contacts on another inner surface.

FIG. 4 illustrates a particular embodiment of a cable 400 adapted to couple an external device to, and power the external device from, an information handling system. The cable 400 includes a plug having a plurality of USB contacts and a plurality of non-USB contacts within a shell 402. The non-USB contacts can include a pin arrangement conforming to an eSATA standard or other pin arrangements. For instance, the non-USB contacts can have the following assignments:

1: GROUND
2: A+
3: A−
4: GROUND
5: B+
6: B−
7: GROUND

The USB contacts can include, for example, a ground contact and a 5 Volt power contact. In a particular embodiment, the USB contacts can also include a plurality of data contacts (not shown). (D+/D−).

The cable 400 can include another plug having a plurality of USB contacts and a plurality of non-USB contacts within another shell 404. The plurality of non-USB contacts within the shell 404 correspond to the non-USB contacts within the shell 402. The plurality of USB contacts within the shell 404 can correspond to the plurality of USB contacts within the shell 402. Alternatively, as shown in FIG. 4, one or more of the plurality of USB contacts within the shell 404 can correspond to one or more of the plurality of USB contacts within the shell 402, while one or more other USB contacts within the shell 404 cannot correspond to one or more other USB contacts within the shell 402. For example, an eighth contact within the shell 402 can correspond to an eight contact or pin within the shell 404, while an eleventh pin within the shell 402 can correspond to a ninth pin within the shell 404.

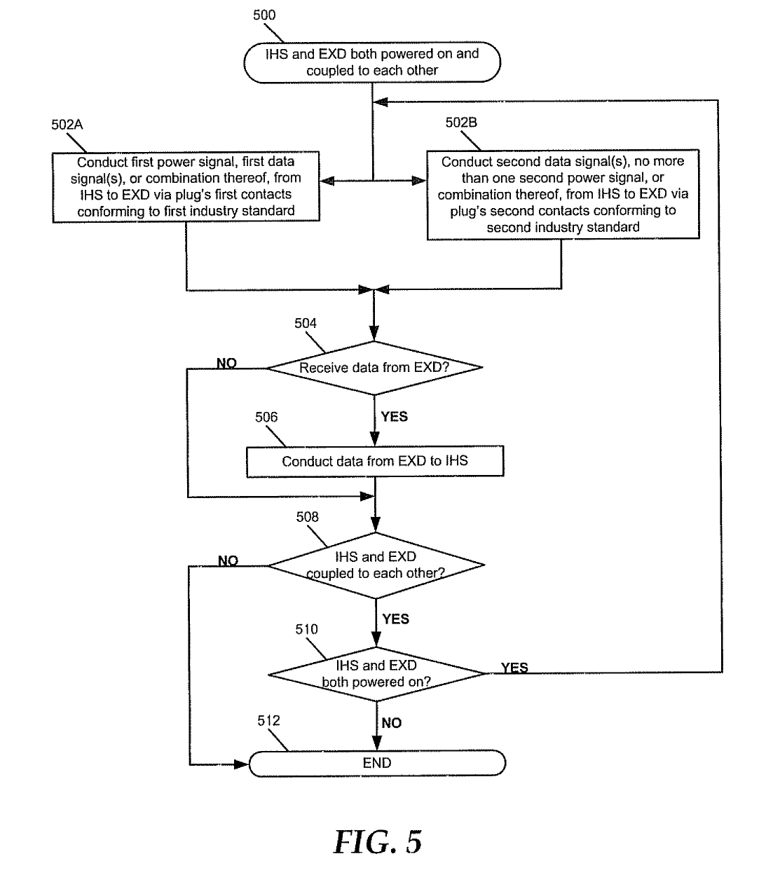

FIG. 5 illustrates a particular embodiment of a method of coupling an external device to, and powering the external device from, an information handling system. At 500, an information handling system (HIS) and an external device (EXD) are coupled to each other and are both powered on. Moving to 502A, a cable conducts a power signal from the IHS to the EXD via contacts of a plug, where the contacts conform to a first industry standard. The cable can also conduct one or more data signals from the IHS to the EXD via the contacts conforming to the first industry standard. Simultaneously, at 502B, the cable conducts one or more additional data signals, no more than one additional power signal, or a combination thereof, from the IHS to the EXD via additional contacts of the plug, where the additional contacts conform to a second industry standard that is different from the first industry standard.

Proceeding to 504, if the cable receives one or more data signals from the EXD, the cable can conduct the data signal(s) to the IHS, at 506. Continuing to 508, if the IHS and the EXD are no longer coupled to each other, the method can terminate at 512. Conversely, if the IHS and the EXD are coupled to each other, the method can advance to 510. If the IHS and the EXD are both powered on, the method can return to 502A and 502B. On the other hand, if either the IHS or the EXD is powered off, the method can terminate at 512.

Many different aspects and embodiments are possible. Some of those aspects and embodiments are described below. After reading this specification, skilled artisans will appreciate that those aspects and embodiments are only illustrative and do not limit the scope of the present invention.

In a first aspect, a plug to couple an external device to, and power the external device from, an information handling system includes first contacts conforming to a first industry standard. The first contacts include a first power contact adapted to conduct a first power signal from the information handling system to the external device. The plug also includes second contacts conforming to a second industry standard different from the first industry standard. The second contacts are designed to conduct no more than one second power signal from the information handling system to the external device. In some examples, the first contacts and the second contacts comprise a plurality of teeth, a plurality of pins, or a combination thereof.

In an embodiment of the first aspect, the first contacts include USB contacts and the second contacts include non-USB contacts. The non-USB contacts can include external serial advanced technology attachment (eSATA) contacts. In another embodiment of the first aspect, the second power contacts include ground contacts. The ground contacts can be adapted to conduct substantially equal voltages from the information handling system to the external device.

In another embodiment of the first aspect, the plug can include a shell having a first inner surface and a second inner surface substantially parallel to the first inner surface. The first contacts are disposed on the first inner surface and the second contacts are disposed on the second inner surface. The shell is adapted to surround a pin substrate of the connector, where third contacts conforming to the first industry standard are disposed on a first side of the pin substrate and fourth contacts conforming to the second industry standard are disposed on a second side of the pin substrate that is substantially parallel to the first side of the pin substrate.

In a further embodiment of the first aspect, the plug can be adapted such that the first contacts are coupled to the third contacts, and the second contacts are coupled to the fourth contacts, simultaneously when the plug is inserted into the connector. For example, the plug can include a tip sized to be received within the connector, and the first contacts and the second contacts are substantially equidistant from the tip of the plug. In one example, the shell can include a metal casing. In other examples, the shell is characterized by a pin arrangement that conforms to an eSATA standard.

In an additional embodiment of the first aspect, the first contacts of the plug include at least one data contact adapted to conduct at least one data signal between the information handling system and the external device.

In a second aspect, an apparatus to couple an external device to, and power the external device from, an information handling system includes a cable having a first end and a second end. A first plug is coupled to the first end. The first plug is adapted to simultaneously communicate via the connector with a first bus of the information handling system and with a second bus of the information handling system. The first bus conforms to a first industry standard and the second bus conforms to a second industry standard different from the first industry standard. The plug includes first contacts conforming to the first industry standard. The first contacts include a first power contact adapted to conduct a first power signal from the information handling system to the external device. The plug also includes second contacts conforming to the second industry standard. The second contacts are designed to conduct data signals and no more than one second power signal from the information handling system to the external device.

In one embodiment of the second aspect, a second plug can be coupled to the second end of the cable, where the second plug is adapted to be connected with the external device and where the second plug is identical to the first plug. In another embodiment of the second aspect, a second plug coupled to the second end of the cable and a third plug are coupled to the second end of the cable, wherein the second plug conforms to the first industry standard and the third plug conforms to the second industry standard. In a further embodiment of the second aspect, the cable includes a plurality of wires connected to the first plug. The plurality of wires are adapted to simultaneously carry (i) data signals and the power signal received at the second contacts, and (ii) a power signal, a data signal, or a combination thereof received at the first contacts. In one example, the second contacts include eSATA contacts. In a further example, the eSATA contacts include data contacts and ground contacts.

According to a third aspect, a method of coupling an external device to, and powering the external device from, an information handling system includes simultaneously conducting, from an information handling system to an external device, (i) a first power signal received via first contacts of a plug coupled to a connector of the information handling system, where the first contacts conform to a first industry standard; and (ii) one or more data signals and no more than one second power signal received via second contacts of the plug coupled to the connector, where the second contacts conform to a second industry standard different from the first industry standard. In one embodiment of the third aspect, the method also includes conducting an additional data signal from the information handling system to the external device, the additional data signal received via the first contacts of the plug coupled to the connector.

Note that not all of the activities described above in the general description or the examples are required, that a portion of a specific activity may not be required, and that one or more further activities may be performed in addition to those described. Still further, the order in which activities are listed are not necessarily the order in which they are performed.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

1. A plug to couple an external device to, and power the external device from, an information handling system, the plug comprising:
first contacts conforming to a USB standard and including a first power contact adapted to conduct a first power signal from the information handling system to the external device; and
second contacts conforming to a non-USB industry standard, wherein the second contacts are designed to conduct no more than one second power signal from the information handling system to the external device;
wherein the second contacts comprise external serial advanced technology attachment (eSATA) contacts and the second contacts are characterized by a pin arrangement that conforms to an eSATA standard.

2. (canceled)

3. (canceled)

4. The plug of claim 1, wherein the second contacts include ground contacts.

5. The plug of claim 4, wherein the ground contacts are adapted to conduct substantially equal voltages from the information handling system to the external device.

6. The plug of claim 1, wherein:
the plug includes a shell having a first inner surface and a second inner surface substantially parallel to the first inner surface, wherein the first contacts are disposed on the first inner surface and the second contacts are disposed on the second inner surface; and
the shell is adapted to surround a pin substrate of a connector, wherein third contacts conforming to the USB standard are disposed on a first side of the pin substrate and fourth contacts conforming to the non-USB industry standard are disposed on a second side of the pin substrate that is substantially parallel to the first side of the pin substrate.

7. The plug of claim 6, wherein the plug is adapted such that the first contacts are coupled to the third contacts, and the second contacts are coupled to the fourth contacts, simultaneously when the plug is inserted into the connector.

8. The plug of claim 7, wherein the plug includes a tip sized to be received within the connector and wherein the first contacts and the second contacts are substantially equidistant from the tip of the plug.

9. The plug of claim 6, wherein the shell comprises a metal casing.

10. (canceled)

11. The plug of claim 1, wherein the first contacts and the second contacts comprise a plurality of teeth, a plurality of pins, or a combination thereof.

12. The plug of claim 1, wherein the first contacts include at least one data contact adapted to conduct at least one data signal between the information handling system and the external device.

13. An apparatus to couple an external device to, and power the external device from, an information handling system, the apparatus comprising:
a cable having a first end and a second end;
a first plug coupled to the first end, wherein the first plug is adapted to simultaneously communicate via a connector with a first bus of the information handling system and with a second bus of the information handling system, wherein the plug includes:
first contacts conforming to the USB standard and including a first power contact adapted to conduct a first power signal from the first bus of the information handling system to the external device; and
second contacts conforming to the non-USB standard, wherein the second contacts are designed to conduct data signals and no more than one second power signal from the second bus of the information handling system to the external device;
wherein the second contacts comprise external serial advanced technology attachment (eSATA) contacts and the second contacts are characterized by a pin arrangement that conforms to an eSATA standard.

14. The apparatus of claim 13, further comprising a second plug coupled to the second end of the cable, the second plug adapted to be connected with the external device, wherein the second plug is substantially identical to the first plug.

15. (canceled)

16. The apparatus of claim 13, wherein the cable includes a plurality of wires connected to the first plug, the plurality of wires adapted to simultaneously carry (i) data signals and the power signal received at the second contacts, and (ii) a power signal, a data signal, or a combination thereof received at the first contacts.

17. (canceled)

18. The apparatus of claim 13, wherein the eSATA contacts include data contacts and ground contacts.

19. A method of coupling an external device to, and powering the external device from, an information handling system, the method comprising:
simultaneously conducting, from the information handling system to the external device:
a first power signal received via first contacts of a first plug coupled to a connector of the information handling system, wherein the first contacts conform to a USB standard; and
one or more data signals and no more than one second power signal received via second contacts of the first plug coupled to the connector of the information handling system, wherein the second contacts conform to an external serial advanced technology attachment (eSATA) standard; and
simultaneously receiving the first power signal, the one or more data signals, and no more than one second power signal, from the information handling system at the external device via a second plug that is connected with the first plug via a cable and that is coupled to a connector of the external device, wherein:
the first power signal is received via contacts of the second plug, wherein the contacts conform to the USB standard; and
the one or more data signals and no more than one second power signal are received via other contacts of the second plug, wherein the other contacts conform to the eSATA standard.

20. The method of claim 19, further comprising conducting an additional data signal from the information handling system to the external device, the additional data signal received via the first contacts of the first plug.
